(19) United States
(12) Patent Application Publication
(10) Pub. No.: US 2011/0052956 A1
(43) Pub. Date: Mar. 3, 2011

(54) BATTERY COVER ASSEMBLY AND PORTABLE ELECTRONIC DEVICE UTILIZING THE SAME

(75) Inventors: PING-KUN FU, Shindian (TW); YU ZHANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/755,493

(22) Filed: Apr. 7, 2010

(30) Foreign Application Priority Data
Aug. 31, 2009 (CN) 200910306360.3

(51) Int. Cl. H01M 2/10

(52) U.S. Cl. 429/97

(57) ABSTRACT

A portable electronic device includes a housing defining a receiving hole, an operating element slidably received in the receiving hole, an elastic element elastically positioned between the housing and the operating element, and a battery cover removably attached to the housing and latching with the operating element. A battery cover assembly is also provided.

### BACKGROUND

1. Technical Field

The exemplary disclosure generally relates to battery cover assemblies and, particularly, to a battery cover assembly and a portable electronic device utilizing the assembly.

2. Description of Related Art

Batteries are widely used in portable electronic devices, such as personal digital assistants (PDAs), mobile phones, and so on. Often, batteries are attachably received in the electronic device, and battery covers provided to connect with housings of the electronic devices to secure the batteries. Batteries are replaced by opening the battery covers when, for example, the batteries are damaged and/or dead (i.e. no longer rechargeable).

Although battery cover assemblies may be simple, the engagement between the battery cover and the housing of the mobile phone can be too strong to allow easy detachment thereof.

Therefore, there is room for improvement within the art.

### BRIEF DESCRIPTION OF THE DRAWINGS

Many aspects of the exemplary portable electronic device can be better understood with reference to the following drawings. The components in the drawings are not necessarily drawn to scale, the emphasis instead being placed upon clearly illustrating the principles of the battery cover assembly. Moreover, in the drawings, like reference numerals designate corresponding parts throughout the several views, in which:

FIG. 1 is an exploded, isometric view of an exemplary embodiment of a portable electronic device as disclosed;

FIG. 2 is a cross-section of a housing of the portable electronic device of FIG. 1;

FIG. 3 is similar to FIG. 1, but viewed from another aspect;

FIG. 4 is an assembled cross-section of a portable electronic device showing an exemplary embodiment of a battery cover assembly as disclosed; and

FIG. 5 is an open view of the cover assembly of FIG. 4.

### DETAILED DESCRIPTION

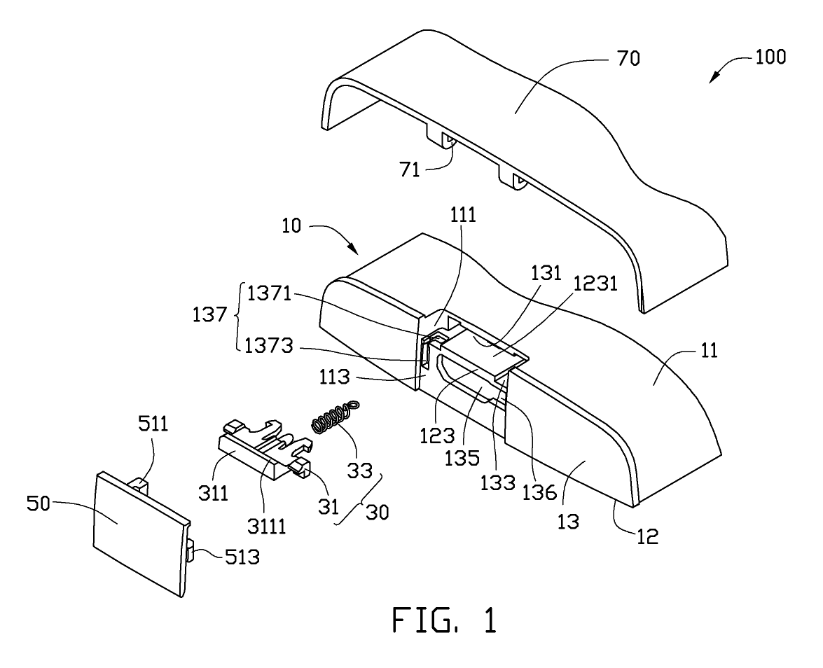

FIG. 1 is an exploded, isometric view of an exemplary embodiment of a portable electronic device 100 as disclosed, such as a cellular phone or any electronic device where battery power is employed. The portable electronic device 100 includes a housing 11, an operating module 30, a protective cover 50 configured to cover the housing 11 and the operating module 30, and a battery cover 70 removably attached to the housing 11.

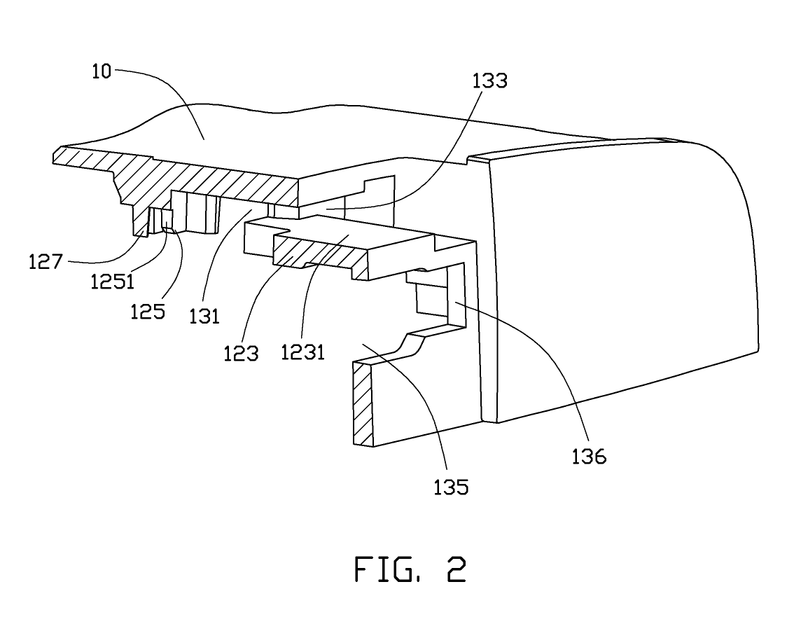

Referring to FIGS. 1 and 2, the housing 10 includes an end portion 13 with a presentation surface 11 and an inner surface 12. The presentation surface 11 defines a cutout 111 and a receiving hole 131 communicating with the cutout 111. The end portion 13 defines a notch 113 communicating with the cutout 111, a connecting hole 135, and a through hole 136 communicating with the connecting hole 135. The connecting hole 135 is configured to receive a connector (not shown) therein. A mounting portion 123 with a supporting surface 1231 is formed between the receiving hole 131 and the connecting hole 135. The housing 11 defines a groove 133 at two sides of the mounting portion 123. The grooves 133 communicate with the receiving hole 131. The housing 11 defines a latching portion 137 including a first slit 1371 defined on the inner surface 12 of one of the grooves 133 and a second slit 1373 defined on the bottom surface of the notch 113. The first slit 1371 communicates with the second slit 1373.

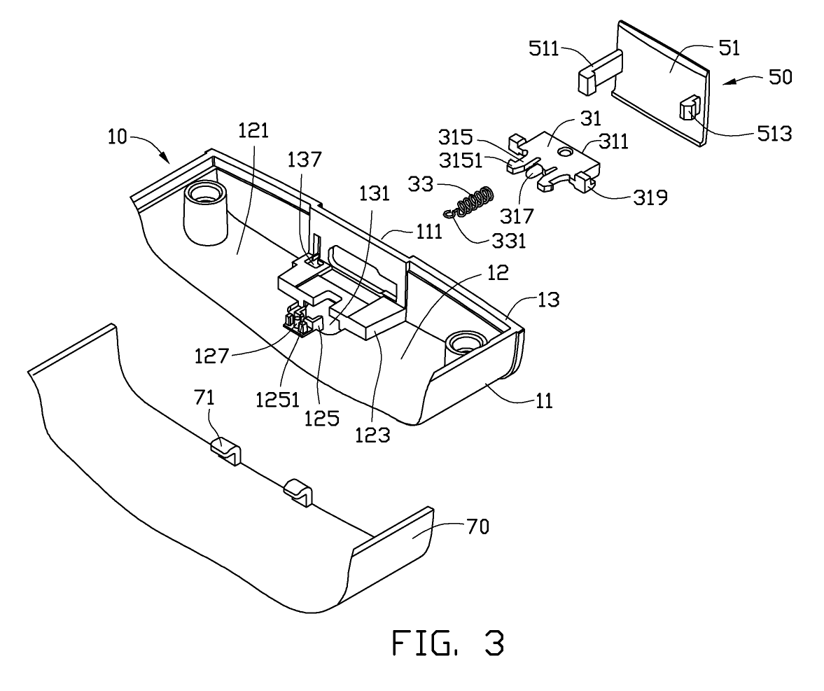

Referring to FIG. 3, the housing 10 defines a chamber 121. The chamber 121 communicates with the receiving hole 131 and the connecting hole 135. The housing 10 forms a positioning portion 125 and a post 127. Both the positioning portion 125 and the post 127 extend upwards from the bottom surface 12 in the chamber 121. The mounting portion 123 connects to the end portion 13. The positioning portion 125 defines a positioning slot 1251 at approximately the middle thereof so the positioning portion 125 is divided into two substantially L-shaped portions facing each other. The post 127 is aligned with the positioning slot 1251.

Referring to FIGS. 1 and 3, the operating module 30 includes an operating element 31 and an elastic element 33. The operating element 31 includes a base 311 with a resisting protrusion 3111 at one end; two resisting arms 315 extending from the other end of the base 311; a pin 317 formed between the two resisting arms 315; and two latching protrusion 319 adjacent to the two resisting arms 315. The two resisting arms 315, of elastic material, each have a stopping protrusion 3151. The stopping protrusions 3151 are configured to abut the mounting portion 123 to prevent the operating element 31 from separating from the housing 10. The pin 317 is configured to guide the elastic element 33. In the exemplary embodiment, the elastic element 33 is a compression spring having a hook 331 on one end.

The protective cover 50 includes a plate 51 having a first latching arm 511 and a second latching arm 513 at two opposite ends. The first latching arm 511 and the second latching arm 513 are configured to attach the protective cover 50 to the housing 11.

The battery cover 70 is configured to cover the housing 11 and enclose a battery (not shown) for the electronic device 100. Two substantially L-shaped tabs 71 project from one end of the battery cover 70. The tabs 71 are configured to be received in the receiving hole 131 and abut the housing 11.

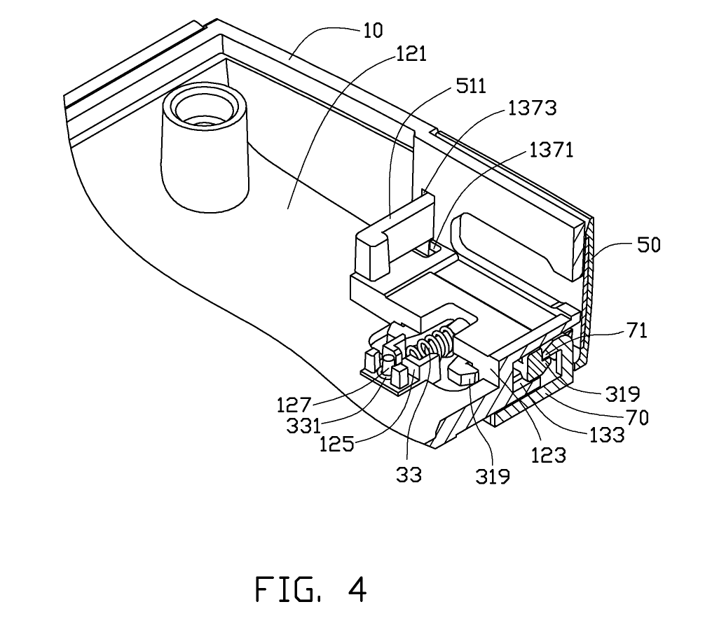

Referring to FIG. 4, during assembly of the portable electronic device 100, the hook 331 of the elastic element 31 is placed over the post 127. The resisting arms 315 are pressed to pass the resisting protrusions 3151 through a corresponding groove 133 and be received in the chamber 121. At the same time, the elastic element 31 is coiled around the post 137 and positioned by the positioning portion 125. The operating element 31 slidably resists the supporting surface 1231, and the latching protrusions 319 are slidably received in the corresponding receiving grooves 133. The first latching arm 511 is received in the first slit 1371 and the second slit 1373 so that the protective cover 50 is pivotably mounted on the housing 11 by the elastic deformation of the first latching arm 511. The battery cover 70 is attached to the housing 11, and the tabs 71 engage the latching protrusions 319 by the elastic force of the elastic element 33. Finally, the protective cover 50 is pivoted to insert the second latching arm 513 into the through hole 136. Thus, the portable electronic device 100 is assembled.

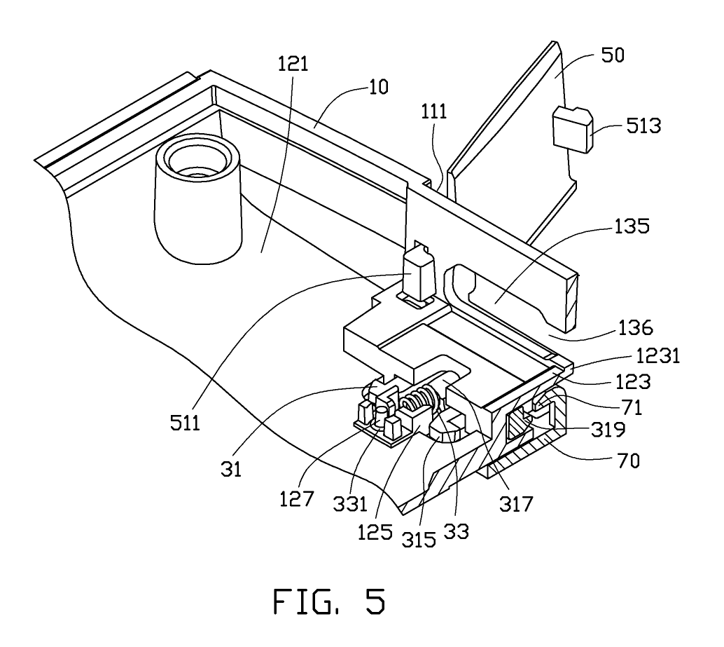

Referring to FIG. 5, when a battery is to be changed or installed, first the protective cover 50 is pivoted to expose the resisting element 31. Then, the resisting protrusion 3111 of the resisting element 31 is pressed (e.g., by finger of the user) to slide the operating element 31 along the supporting surface 1231 toward the positioning portion 125. The latching protrusions 319 thus separate from the tabs 71 of the battery cover 70 which can, accordingly, be removed from the housing 10. At the same time, the elastic element 33 is elastically deformed, whereby operating element 31 withdraws by the elastic force thereof on release.

It is notable that connecting hole 135 can be defined where a connector is desirable while covered by the protective cover 50.

In the exemplary embodiment of the portable electronic device 100, by pressing the operating element 31, the battery cover 70 could be removed from the housing 11 such that it is easy to use. Furthermore, the portable electronic device 100 has a protective cover 50 to cover the operating element 31 to prevent the portable electronic device 100 from dust or water penetrating.

It is believed that the present embodiments and their advantages will be understood from the foregoing description, and it will be apparent that various changes may be made thereto without departing from the spirit and scope of the disclose or sacrificing all of its material advantages, the examples hereinbefore described merely being preferred or exemplary embodiments of the disclosure.

What is claimed is:

1. A battery cover assembly comprising:
a housing defining a receiving hole;
an operating module comprising an operating element slidably received in the receiving hole, and an elastic element elastically positioned between the housing and the operating element;
a battery cover removably attached to the housing and latching with the operating element.

2. The battery cover assembly as claimed in claim 1, further comprising a protective cover pivotably mounted on the housing, shielding the operating element.

3. The battery cover assembly as claimed in claim 2, wherein the protective cover comprises two latching arms and the housing includes a latching portion and defines a through hole in which one of the latching arms is received while the other latching arm is elastically deformed and mounted in the latching portion.

4. The battery cover assembly as claimed in claim 3, wherein the latching portion comprises a first slit and a second slit communicating with the first slit, and one of the latching arms is received in the first slit and the second slit.

5. The battery cover assembly as claimed in claim 2, wherein the housing defines a connecting hole for covering by the protective cover.

6. The battery cover assembly as claimed in claim 1, wherein the operating element forms two latching protrusions, the housing defines two receiving grooves communicating with the receiving hole, and each latching protrusion is slidably received in a corresponding receiving groove.

7. The battery cover assembly as claimed in claim 1, wherein the operating element comprises two resisting arms and the housing comprises a mounting portion which the resisting arms resist.

8. The battery cover assembly as claimed in claim 1, wherein the operating element comprises a pin; the housing forms a post; one end of the elastic element is coiled around the pin and the other end of the elastic element is attached to the post.

9. The battery cover assembly as claimed in claim 1, wherein the housing comprises a positioning portion defining a positioning slot forming a path through which the elastic element passes.

10. The battery cover assembly as claimed in claim 1, wherein the battery cover forms two tabs; the operating element forms two latching protrusions; and each tab engages a corresponding latching protrusion.

11. A portable electronic device comprising:
a housing defining a receiving hole;
an operating element slidably received in the receiving hole;
an elastic element elastically disposed between the housing and the operating element; and
a battery cover removably attached to the housing and latching with the operating element.

12. The portable electronic device as claimed in claim 11, wherein the battery cover assembly further comprises a protective cover pivotably mounted on the housing and for shielding the operating element.

13. The portable electronic device as claimed in claim 12, wherein the protective cover comprises two latching arms and the housing comprises a latching portion and defines a through hole in which one of the latching arms is received, and the other latching arm is attached to the latching portion.

14. The portable electronic device as claimed in claim 13, wherein the latching portion comprises a first slit communicating with a second slit, wherein one of the latching arms is received in the first slit and elastically deformed and received in the second slit.

15. The portable electronic device as claimed in claim 12, wherein the housing defines a connecting hole for shielding by the protective cover.

16. The portable electronic device as claimed in claim 11, wherein the operating element forms two latching protrusions, the housing defines two receiving grooves communicating with the receiving hole, and each latching protrusion is slidably received in a corresponding receiving groove.

17. The portable electronic device as claimed in claim 11, wherein the elastic element comprises two resisting arms resisting a mounting portion of the housing.

18. The portable electronic device as claimed in claim 11, wherein the operating element comprises a pin and the housing forms a post; wherein one end of the elastic element is coiled around the pin and the other end is attached to the post.

19. The portable electronic device as claimed in claim 11, wherein the housing comprises a positioning portion defining a positioning slot forming a path through which the elastic element passes.

20. The portable electronic device as claimed in claim 11, wherein the battery cover forms two tabs; the elastic element forms two latching protrusions; and each tab engages a corresponding latching protrusion.
